(19) United States
(12) Patent Application Publication
(10) Pub. No.: US 2009/0257315 A1
(43) Pub. Date: Oct. 15, 2009

(54) POSITION TRACING SIGNAL GENERATOR UNIT AND INPUT SYSTEM HAVING THE SAME

(75) Inventors: Do-Young Ko, Seoul (KR); Jae-Jun Lee, Seoul (KR)

Correspondence Address: CANTOR COLBURN, LLP, 20 Church Street, 22nd Floor, Hartford, CT, 06103, US

(73) Assignee: PENANDFREE CO., LTD., Seoul (KR)

(21) Appl. No.: 12/100,855

(22) Filed: Apr. 10, 2008

(51) Int. Cl. H04B 1/02; H04B 1/06

(52) U.S. Cl. 367/135; 367/137

(57) ABSTRACT

Disclosed are a position tracing signal generator unit and an input system using the same. The position tracing signal generator unit of the present invention generates ultrasonic signals with a constant time interval to allow ultrasonic signals generated from a plurality of ultrasonic signal generator to be overlapped and amplified. It is possible to increase the intensity of the ultrasonic signal and lengthen the range. Due to the structural advantages of the present invention as described above, it is possible to solve a problem of the prior art, i.e., a large thickness of the position tracing signal generator unit caused by a large size of the ultrasonic sensor for increasing the intensity of the ultrasonic signal.

### BACKGROUND OF THE INVENTION

1. Field of the Invention

The present invention relates to a position tracing signal generator unit and an input system including a position tracing input device for tracing a position of the position tracing signal generator unit and inputting information.

2. Description of the Related Art

A position tracing input device is a device for recognizing the position of the position tracing signal generator unit moved by a user, and inputting information on the position of a signal generator unit and its trace. Currently, the position tracing input device is implemented using a natural handwriting input system together with a position tracing signal generator unit as an input pen. For simplicity of description, the present invention will be described by exemplifying a position tracing signal generator unit and a position tracing input device as a natural handwriting input system.

Unlike a natural handwriting recognition method in a tablet PC, in the natural handwriting input system, a coordinate value of the input pen is recognized by calculating a distance based on a time difference between the times that the natural handwriting input device receives reference signals and ultrasonic signals generated from the input pen, and a trace of the input pen is recognized by connecting the coordinate values along the movement of the input pen. The reference signal may include infrared (IR), radio frequency (RF), or electromagnetic (EM) induction signals.

A conventional position tracing signal generator unit is illustrated in FIG. 1. Referring to FIG. 1, a conventional position tracing signal generator unit is a pen type, and includes: a power supply 15 for supplying power to the main body 10 of the input pen; a reference signal generator 13 for generating a reference signal; an ultrasonic generator 17 for generating ultrasonic signals; and a controller 11 for controlling the reference signal generator 13 and ultrasonic generator 17.

Also, the conventional position tracing signal generator unit includes a pen core 19 which pass through the center of the main body in order to store inks to allow a user to actually take a note on a paper or simply improve a writing sensibility of a user. The pen core 19 passes through an ultrasonic generator 17 having a cylindrical shape, and is combined with the main body 10 while an external housing 20 encapsulates the ultrasonic generator 17 and the pen core 19. The ultrasonic generator 17 is typically formed of a piezoelectric film.

As shown in FIG. 1, the external housing has slots 220 for emanating the ultrasonic waves generated from the ultrasonic generator 17 to the outside.

Meanwhile, the longer range of the ultrasonic signal generated from the ultrasonic generator 17 of the conventional position tracing signal generator unit can be obtained as the output power of the ultrasonic signal increases.

Therefore, when a sensor for receiving the ultrasonic signal in the input system is closely disposed from the position tracing signal generator unit, the intensity of the ultrasonic signal generated from position tracing signal generator unit is not matter. However, when the sensor is disposed far from the position tracing signal generator unit, the ultrasonic signal cannot reach the ultrasonic signal sensor, and the position of the position tracing signal generator unit cannot be accurately traced.

In order to solve the above problem, a method of intensifying the output power of the ultrasonic signal has been proposed. However, in order to increase power of the ultrasonic signal, the length of the piezoelectric film for covering the outer face of the pen core 19 becomes large. In proportion to the increased length, the thickness of the position tracing signal generator unit implemented as the input pen becomes large, so that a user may feel uncomfortable.

### SUMMARY OF THE INVENTION

The present invention provides a position tracing signal generator unit and an input system using the same, by which the range of the ultrasonic signal can be lengthened without increasing the thickness of the position tracing signal generator unit.

According to an aspect of the present invention, there is provided a position tracing signal generator unit comprising: a plurality of ultrasonic signal generators which are separated by a predetermined distance and generate respective ultrasonic signals based on an ultrasonic control signal; a controller which generates the ultrasonic control signal and outputs the ultrasonic control signal to a plurality of the ultrasonic signal generators so that the ultrasonic signals generated from a plurality of ultrasonic signal generators can be overlapped and amplified; and a guide which includes emission slots for emanating the ultrasonic signals, internally stores a plurality of ultrasonic signal generators, and is combined with a main body supporting the ultrasonic signal generators.

The controller may generate and output the ultrasonic control signals with a constant time interval in sequence starting from the farthest ultrasonic signal generator to the closest ultrasonic signal generator with respect to the emission slots in order to overlap the ultrasonic signals and emanate the overlapped ultrasonic signals through the emission slots.

The position tracing signal generator unit may further comprise a reference signal generator which generates a reference signal based on a reference control signal, wherein the controller generates the reference control signal so as to generate the reference signal at the same time period as that of the ultrasonic signal generated from the ultrasonic signal generator, and output the reference control signal to the reference signal generator.

According to another aspect of the present invention, there is provided an input system comprising: the position tracing signal generator unit described above; and a position tracing input device which includes a reference signal sensor for receiving the reference signal generated from the position tracing signal generator unit and a plurality of ultrasonic signal sensors separated from one another to receive an amplified ultrasonic signal from the position tracing signal generator unit, and measures a position of the position tracing signal generator unit using a time difference between a time that the reference signal sensor receives the reference signal and a time that a plurality of ultrasonic signal sensors receive the ultrasonic signals.

According to still another aspect of the present invention, there is provided an input system comprising: a position tracing signal generator unit which include a plurality of ultrasonic signal generators separated from one another to generate ultrasonic signals based on a predetermined ultrasonic control signal, and a guide in which emission slots for emanating the ultrasonic signals are formed and which is combined with a main body supporting the ultrasonic signal generators and internally stores a plurality of the ultrasonic signal generators; and a position tracing input device which is connected to the position tracing signal generator unit through a wire in order to generate the ultrasonic control signal so as to overlap the ultrasonic signals generated from a plurality of the ultrasonic signal generators at a predetermined time period for amplification, and output the ultrasonic control signal to a plurality of the ultrasonic signal generators.

The position tracing input device may generate and output the ultrasonic control signals with a constant time difference in sequence starting from the farthest ultrasonic signal generator to the closest ultrasonic signal generator with respect to the emission slots so as to emanate the overlapped ultrasonic signals through the emission slots.

The position tracing input device may measure a position of the position tracing signal generator unit using a time difference between a time that the ultrasonic control signal is output to the closest ultrasonic signal generator and a time that each of the ultrasonic signal sensors receives the ultrasonic signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a configuration of a conventional position tracing signal generator unit;

FIG. 2 is a schematic view illustrating a configuration of a position tracing signal generator unit according to a first embodiment of the present invention;

FIG. 3 is a cross-sectional view illustrating a guide coupled with a main body shown in FIG. 2, according to the first embodiment of the present invention;

FIG. 4 is a view illustrating waveforms of ultrasonic signals generated according to the first embodiment of the present invention and a waveform of an overlapped signal of the ultrasonic signals;

FIG. 5 is a schematic view for explaining a whole configuration of an input system and an input method according to the first embodiment of the present invention; and

FIG. 6 is a schematic view for explaining a whole configuration of an input system and an input method according to a second embodiment of the present invention.

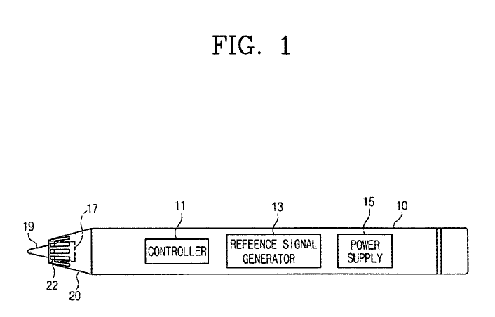

### DETAILED DESCRIPTION OF THE INVENTION

Hereinafter, exemplary embodiments of the present invention will be described with reference to the accompanying drawings.

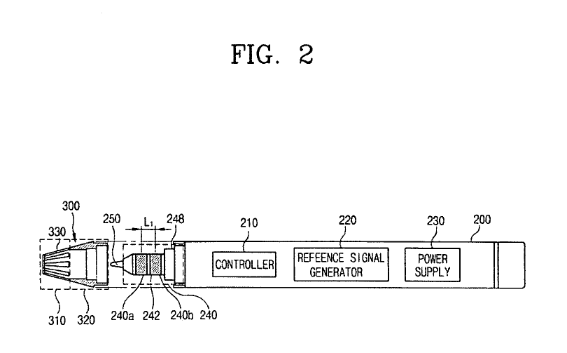

FIG. 2 is a schematic view illustrating a configuration of a position tracing signal generator unit according to an embodiment of the present invention. Referring to FIG. 2, a position tracing signal generator unit according to an embodiment of the present invention comprises, in a physical configuration, a main body 200, and a guide 300 coupled with the main body 200.

The main body 200 includes a power supply 230, an ultrasonic signal generation unit 240, a reference signal generator 220, a controller 210, and a pen core 250. The power supply 230 supplies power to the ultrasonic signal generation unit 240, the reference signal generator 220, and the controller 210. The reference signal generator 220 receives the supplied power and generates a reference signal based on a reference control signal input from the controller 210. In the present invention, the reference signal may include an infrared (IR) signal, a radio frequency (RF) signal, or an electromagnetic (EM) induced signal.

The pen core 250 may be provided at the end of the ultrasonic signal generation unit 240 so as to provide a writing sensibility of a typical pen. Also, inks may be contained in the inside of the pen core 250 to allow a user to actually write. In this case, the pen core 250 may pass through the ultrasonic signal generation unit 240 and be inserted into the main body 200.

The ultrasonic signal generation unit 240 comprise: a plurality of ultrasonic signal generators 240a and 240b which generate ultrasonic signals through vibration based on an ultrasonic control signal input from the controller 210; an inner pipe 242 of which central portion is provided with a cylindrical space for receiving the pen core 250; and a support 248 which is closely engaged with an inner surface of the guide 300 to fix a position of the ultrasonic signal generators 240.

Preferably, the ultrasonic signal generators 240a and 240b are separated from each other by a predetermined distance L1 so as to surround an outer face of the inner pipe 242. Alternatively, the ultrasonic signal generators 240a and 240b may be provided to only a predetermined region of the inner pipe 242. The ultrasonic signal generators 240a and 240b generates the ultrasonic signals by converting electric energy supplied from the power supply 230 to vibration energy based on the ultrasonic control signal. Preferably, the ultrasonic signal generators are constructed with a piezoelectric film.

Although two ultrasonic signal generators 240a and 240b are illustrated in FIG. 2, three or more ultrasonic signal generators may be provided. In addition, although the ultrasonic signal generators may be separated from each other by different distances, it is preferable that the ultrasonic signal generators are separated from each other by an equal distance.

In addition, as shown in FIG. 2, it is preferable that the ultrasonic signal generators 240 are disposed at a position (for example, a lower end of an input pen) closer to a paper sheet when a user performs writing by using an input pen. The controller 210, the reference signal generator 220, and the power supply 230 may be disposed at any position in the main body 200.

In the inner portion of the guide 300, a space for receiving the ultrasonic signal generators 240 is provided. The guide 300 surrounding the ultrasonic signal generators 240 received therein is coupled with the main body 200.

The guide 300 includes a lower guide 310 and an upper guide 320. The cross-section of the upper guide 320 has a locking structure such as threads in order to allow interlocking with the main body 200 by fitting, screwing, or adhesive bonding.

Emission slots 330 are provided on an outer face of the lower guide 310 in order to emanate ultrasonic signals generated from the ultrasonic signal generators 240a and 240b stored in the guide 300. Preferably, the emission slots 330 are elongated to allow the entire the lowermost ultrasonic signal generator 240a adjacent to the ground to be sufficiently exposed. That is, the emission slots 330 are designed to allow the ultrasonic signals generated from the lowermost ultrasonic signal generator 240a to be directly emanated to the air without propagating through a guide path provided between the ultrasonic signal generation unit 240 and the guide 300.

Meanwhile, the upper guide 320 forms a guide path in association with the upper ultrasonic generator 240b in order to emanate through the emission slots 330 the ultrasonic signals generated from the upper ultrasonic signal generator 240b which is internally stored. As a result, the ultrasonic signals generated from the upper ultrasonic signal generator 240b are guided down to the ground along the guide path and emanated to the air.

It is noted that, assuming three ultrasonic generators are provided, two upper ultrasonic generators except the lowermost ultrasonic generator may be surrounded by the upper guide 320, so that the ultrasonic signals generated therefrom are guided to the air through the emission slots 330 along the guide path.

Meanwhile, the controller 210 outputs an ultrasonic control signal and a reference control signal to the ultrasonic signal generation unit 240 and the reference signal generator 220 in order for the ultrasonic signal generation unit 240 and the reference signal generator 220 to generate the ultrasonic signals and the reference signals, respectively, at a predetermined time period. It is noted that the control unit 210 generates and outputs the ultrasonic control signal and the reference control signal to generate the ultrasonic signal and the reference signal at the same time period (i.e., at the same generation frequency). The reference control signal and the ultrasonic control signal may be output concurrently with each other or separately at a constant time difference.

The controller 210 generates ultrasonic control signals and outputs them to respective ultrasonic signal generators 240a and 240b. The ultrasonic signals generated from ultrasonic signal generators 240a and 240b at a predetermined time interval are overlapped with each other and amplified.

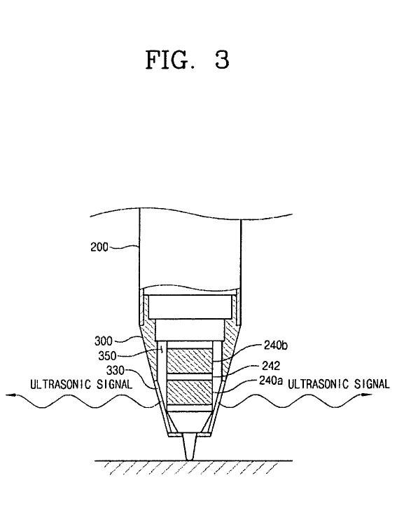

FIG. 3 is a schematic view illustrating a cross-section of the guide 300 engaged with the main body 200 according to an embodiment of the present invention. Referring to FIG. 3, when an ultrasonic signal generation unit 240 is inserted into the guide 300, the pen core 250 is protruded through the inner pipe 242 of the ultrasonic signal generation unit 240 and the lower guide 310. The main body 200 is closely engaged with the upper guide 320 so that the ultrasonic waves generated from the ultrasonic signal generators 240a and 240b cannot be emanated in a direction opposite to the ground.

With the ultrasonic signal generation unit 240 being inserted into the guide 300, a guide path 350 is formed between the inner pipe 242 of the ultrasonic signal generation unit 240 and an inner face of the guide 300, and the ultrasonic signals generated from the ultrasonic signal generators 240b propagate along the guide path 340 so as to be emanated through the emission slots 330.

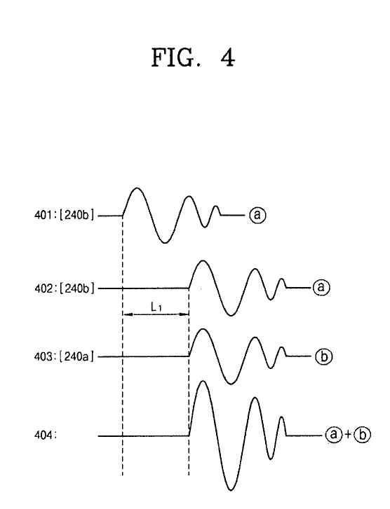

FIG. 4 illustrates a process of amplification by overlapping ultrasonic signals and waveforms of ultrasonic signals generated according to the first embodiment of the present invention. Referring to FIG. 4, the controller 210 generates an ultrasonic control signal for instructing to generate ultrasonic signals and outputs it to ultrasonic signal generator 240b.

The ultrasonic signal generator 240b receives the ultrasonic control signal and generates the ultrasonic signals (401: refer to \textcircled{a} of FIG. 4).

The ultrasonic signals \textcircled{a} generated from the ultrasonic signal generator 240b propagate toward the emission slots 330 along the guide path 350 (402).

On the other hand, when the ultrasonic signal \textcircled{a} generated from the ultrasonic signal generator 240b arrives at the ultrasonic signal generator 240a, i.e., when the ultrasonic signal \textcircled{a} propagates by a distance L1 between the ultrasonic signal generators 240a and 240b, the ultrasonic control signal is output to the ultrasonic signal generator 240a to generate an ultrasonic signal having the same frequency and phase as those of the previous ultrasonic signal (403: refer to \textcircled{b} of FIG. 4).

Then, the ultrasonic signals \textcircled{a} and \textcircled{b} are overlapped with each other to generate an amplified ultrasonic signal (\textcircled{a}+\textcircled{b}). The amplified ultrasonic signal is emanated to the air through the emission slots 330.

The controller 210 generates a reference control signal so that the reference signal is generated at the same time period (i.e. at the same generation frequency) as that of ultrasonic signal regardless of the time point that the ultrasonic signal is generated and outputs the reference control signal to reference signal generator 220.

That is, the controller 210 may generate the reference control signal to allow the reference signal to be generated at the same generation frequency as that of the ultrasonic signal and with a constant time interval from the time point that the ultrasonic signal is generated, and output it to the reference signal generator 220.

In addition, the controller 210 may generate a reference control signal for instructing to generate the reference signal simultaneously with generation of the ultrasonic signal from either of the farther ultrasonic signal generator 240b or the closer ultrasonic signal generator 240a with respect to the emission slots 330.

According to the first embodiment of the present invention, the ultrasonic control signal and the reference control signal are simultaneously outputted to the ultrasonic signal generator 240a and the reference signal generator 220, respectively, in order to simultaneously emanate the amplified ultrasonic signal and the reference signal.

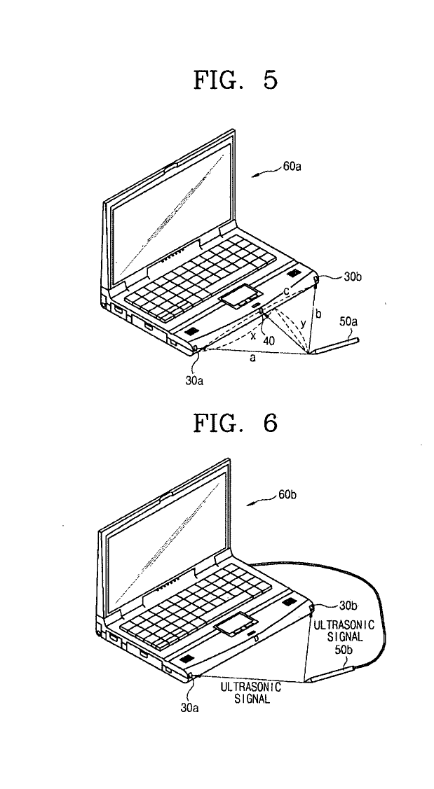

FIG. 5 illustrates a whole configuration of an input system and an input method according to the first embodiment of the present invention.

Operations of the input system according to an embodiment of the present invention will now be described with reference to FIG. 5. A controller 210 of a position tracing signal generator unit 50a (hereinafter, referred to as an “input pen”) obtained by combining the main body 200 and the guide 300 generates a reference control signal and an ultrasonic control signal at the same time period (i.e., at the same generation frequency) to output them to the reference signal generator 220 and the ultrasonic signal generation unit 240. As described above, the ultrasonic signal and the reference signal may be generated simultaneously or respectively with a constant time interval.

When the control signal is input from the controller 210, the reference signal generator 220 generates the reference signal. Also, the ultrasonic signal generators 240a and 240b sequentially generate the ultrasonic signals with a constant time interval as described above. The generated ultrasonic signals are overlapped and amplified with each other, and then output to the air through the emission slots 330.

The position tracing input device 60a comprises a reference signal sensor 40 for receiving the reference signal and a plurality of ultrasonic signal sensors 30a and 30b for receiving the ultrasonic signals. It should be noted that the ultrasonic signal sensors 30a and 30b are separated from each other by a predetermined distance.

A method of measuring coordinate values of the input pen 50a according to the first embodiment of the present invention will be described by exemplifying a case where the reference signal and the ultrasonic signal are simultaneously generated.

The coordinate value (x, y) of the input pen 50a may be obtained by solving the following Equation 1 for x and y:

a²=x²+y², and [Equation 1]

b²=(c−x)²+y².

Assuming that a radio or infrared frequency signal (i.e., the reference signal) propagate at a velocity of the light, and thus, the reference signal is received by the reference signal sensor 40 as soon as the reference signal is generated in the input pen 50a, the lengths a and b may be obtained by multiplying a sound velocity by the time taken for receiving the reference signal and by a difference between the times taken for receiving the ultrasonic signal by the left-side ultrasonic sensor 30a and the right-side ultrasonic sensor 30b, respectively. Also, since the length c is previously set, the coordinate value (x, y) can be obtained by applying the values of a, b, and c to the Equation 1. It is possible to enter the handwritten script by a user using the coordinate values obtained by tracing the input pen 50a.

When the reference signal and the ultrasonic signal are generated from the input pen 50a at the same frequency (i.e., at the same time period) and at a constant time difference, the time difference may be applied to the above Equation 1 to obtain the position of the input pen 50a. For example, if the reference signal preceding the ultrasonic signal by the time (α) is generated from the input pen 50a, the position of the input pen 50a may be measured by using the time that the ultrasonic signal is received by each ultrasonic sensor after the reference signal is received and the time (α) is elapsed.

FIG. 6 illustrates a whole configuration of an input system and an input method according to a second embodiment of the present invention.

The position tracing signal generator unit 50b according to a second embodiment has a similar structural configuration to that of the first embodiment in the ultrasonic signal generation unit 240 and the guide 300. However, the controller 210, the reference signal generator 220, and the power supply 230 provided in the main body 200 are omitted.

Specifically, the structural configuration of the second embodiment is similar to that of the first embodiment in that the ultrasonic signal generation unit 240 and the pen core 250 is contained in the main body 200, and the guide 300 is engaged with the main body 200 while internally stores the ultrasonic signal generation unit 240. The structural configuration of the second embodiment is different from that of the first embodiment in that the controller 210, the reference signal generator 220, and the power supply 230 are omitted, and the ultrasonic signal generation unit 240 receives the ultrasonic control signal and power from the position tracing input device 60b through a wire to generate the ultrasonic signal. Only the components and operations different from those of the first embodiment will be described.

Referring to FIG. 6, the position tracing signal generator unit 50b according to the second embodiment is connected to the position tracing input device 60b through a wire to receive power. Also, the position tracing input device 60b generates the ultrasonic control signal at a predetermined time period for instructing the position tracing signal generator unit 50b (also, referred to as an input pen) to generate the ultrasonic signal, and then, outputs it to the input pen 50b.

Each of the signal generators 240a and 240b of the input pen 50b that has received the ultrasonic control signal generates ultrasonic signals at a predetermined time interval, and emanates the amplified ultrasonic signal through the emission slots 330. The ultrasonic signals are received by a plurality of ultrasonic sensors 30a and 30b provided in the position tracing input device 60b.

The position tracing input device 60b may set the time for outputting the ultrasonic control signal to the input pen 50b as a reference time, and use a time difference from the reference time to the moment that the ultrasonic signals are received by a plurality of ultrasonic sensors 30a and 30b to measure the position of the input pen 50b and perform an input operation similarly to the first embodiment. The reference time may be set as the time that the ultrasonic control signal is output to the ultrasonic generator 240a which is close to the emission slots 330.

As described above, in the position tracing signal generator unit of the present invention, ultrasonic signals are generated from a plurality of ultrasonic signal generators with a constant time interval and then overlapped and amplified. As a result, it is possible to increase the intensity of the ultrasonic signal and lengthen the range.

Also, due to the structural advantages of the present invention as described above, it is possible to solve a problem of the prior art, i.e., a large thickness of the position tracing signal generator unit caused by a large size of the ultrasonic sensor for increasing the intensity of the ultrasonic signal.

While the position tracing signal generator unit and the input system using the same have been described with reference to exemplary embodiment of the present invention, it would be appreciated by those skilled in the art that various modifications can be made without departing from the scope and spirit of the present invention.

For example, although two ultrasonic signal generators 240a and 240b are included in the ultrasonic signal generation unit 240 in the above description, three or more ultrasonic signal generators maybe provided at a constant distance. In this case, the ultrasonic signals may be generated in sequence starting from the uppermost ultrasonic signal generator at a time interval corresponding to a distance between adjacent ultrasonic signal generators, so that ultrasonic signals can be amplified and then emanated.

Accordingly, the disclosed exemplary embodiments should be considered from a descriptive sense rather than a limitative sense. The scope of the present invention is to be accorded the broadest interpretation of the appended claims rather than the above descriptions so as to encompass all such modifications and their equivalents.

What is claimed is:

1. A position tracing signal generator unit comprising:
a plurality of ultrasonic signal generators which are separated by a predetermined distance and generate respective ultrasonic signals based on an ultrasonic control signal;
a controller which generates the ultrasonic control signal and outputs the ultrasonic control signal to a plurality of the ultrasonic signal generators so that the ultrasonic signals generated from a plurality of ultrasonic signal generators can be overlapped and amplified; and
a guide which includes emission slots for emanating the ultrasonic signals, internally stores a plurality of ultrasonic signal generators, and is combined with a main body supporting the ultrasonic signal generators.

2. The position tracing signal generator unit according to claim 1, wherein the controller generates and outputs the ultrasonic control signals with a constant time interval in sequence starting from the farthest ultrasonic signal generator to the closest ultrasonic signal generator with respect to the emission slots in order to overlap the ultrasonic signals and emanate the overlapped ultrasonic signals through the emission slots.

3. The position tracing signal generator unit according to claim 2, further comprising a reference signal generator which generates a reference signal based on a reference control signal,
wherein the controller generates the reference control signal so as to generate the reference signal having the same frequency as that of the ultrasonic signal generated from the ultrasonic signal generator, and outputs the reference control signal to the reference signal generator.

4. an input system comprising:
the position tracing signal generator unit according to claim 3; and
a position tracing input device which includes a reference signal sensor for receiving the reference signal generated from the position tracing signal generator unit and a plurality of ultrasonic signal sensors separated from one another to receive an amplified ultrasonic signal from the position tracing signal generator unit, and measures a position of the position tracing signal generator unit using a time difference between a time that the reference signal sensor receives the reference signal and a time that a plurality of ultrasonic signal sensors receive the ultrasonic signals.

5. An input system comprising:
a position tracing signal generator unit which include
a plurality of ultrasonic signal generators separated from one another to generate ultrasonic signals based on a predetermined ultrasonic control signal, and
a guide in which emission slots for emanating the ultrasonic signals are formed and which is combined with a main body supporting the ultrasonic signal generators and internally stores a plurality of the ultrasonic signal generators; and
a position tracing input device which is connected to the position tracing signal generator unit through a wire in order to generate the ultrasonic control signal so as to overlap the ultrasonic signals generated from a plurality of the ultrasonic signal generators at a predetermined time period for amplification, and output the ultrasonic control signal to a plurality of the ultrasonic signal generators.

6. The input system according to claim 5, wherein the position tracing input device generates and outputs the ultrasonic control signals with a constant time difference in sequence starting from the farthest ultrasonic signal generator to the closest ultrasonic signal generator with respect to the emission slots so as to emanate the overlapped ultrasonic signals through the emission slots.

7. The input system according to claim 6, wherein the position tracing input device measures a position of the position tracing signal generator unit using a time difference between a time that the ultrasonic control signal is output to the closest ultrasonic signal generator and a time that each of the ultrasonic signal sensors receives the ultrasonic signal.
